(19) United States
(12) Patent Application Publication
(10) Pub. No.: US 2015/0272079 A1
(43) Pub. Date: Oct. 1, 2015

(54) METERED GRAVITY FEEDER FOR DEER

(71) Applicant: Gary K. Evans, Kilgore, TX (US)

(72) Inventor: Gary K. Evans, Kilgore, TX (US)

(21) Appl. No.: 14/226,909

(22) Filed: Mar. 27, 2014

(51) Int. Cl. A01K 5/02

(52) U.S. Cl. CPC A01K 5/0225

(57) ABSTRACT

A feeder configured to feed deer. The feeder comprises a container configured to store feed. The feeder also comprises a feed dispenser physically associated with the container. The feed dispenser has an output that is programmable. The feed dispenser is configured to dispense a portion of the feed from the container through the output. The feeder further comprises a tube system with an input in communication with the output of the feed dispenser. The tube system is configured to receive at the input the portion of the feed dispensed by the feed dispenser through the output of the feed dispenser and hold the feed in a position accessible by deer.

### BACKGROUND INFORMATION

1. Field

The present disclosure relates generally to a feeder, in particular, to a method and apparatus for metering portions of feed. Still more particularly, the present disclosure relates to a method and apparatus for feeding deer.

2. Background

Feeders are used to feed wildlife for various reasons. For example, feeders may be used to attract wildlife to a particular location. As another example, feeders may be used to supplement natural food sources of wildlife.

Operators use feeders to dispense feed suitable for the animals they are feeding. For example, some operators use deer feeders to feed corn to deer. However, wildlife other than deer also feed on corn.

Deer are known to move around and feed at particular times of day. Operators program deer feeders to dispense feed to deer at these times of the day. When a readily available supply of feed is dispensed from a metered sling feeder, the deer will learn to visit the feeder on a daily basis. In this way, operators increase the odds of deer being at or around their feeders. However, when a readily available supply of feed is dispensed from a metered sling feeder, wildlife other than deer also learn to feed at the feeder.

Some metered sling feeders make unique sounds while dispensing feed. Deer learn these unique sounds associating the sounds with availability of the feed at the particular location where the sound is coming from. These sounds further increase the odds of deer approaching the feeders at times desired by operators.

Some wildlife other than deer, however, may also learn the unique sounds and may also approach the feeder at the same times of day that the feeder dispenses the feed. However, feeding other wildlife other than the deer will result in increased amounts of the feed needing to be distributed. As a result, your feeder may need to be replenished more often than desired. This type feeding may increase the cost and effort for feeding deer.

Therefore, it would be advantageous to have an apparatus and system that takes into account at least some of the issues discussed above, as well as other possible issues.

### SUMMARY

In one illustrative embodiment, a feeder comprises a container configured to store feed. The feeder also comprises a feed dispenser physically associated with the container and having an output. The feed dispenser is configured to dispense a portion of the feed from the container through the output. The feeder further comprises a tube system having an input in communication with the output of the feed dispenser. The tube system is configured to receive at the input the portion of the feed dispensed by the feed dispenser through the output of the feed dispenser and hold the feed in a position accessible by deer.

In another illustrative embodiment, a system to feed deer comprises a containing unit configured to store feed. The system also comprises a feed dispensing unit physically associated with the containing unit and having an output, wherein the feed dispensing unit is configured to dispense a portion of the feed from the containing unit through the output. The system further comprises a tube system having an input in communication with the output of the feed dispensing unit, wherein the tube system is configured to receive at the input the portion of the feed dispensed by the feed dispensing unit through the output of the feed dispenser and hold the feed in a position accessible by deer.

In yet another illustrative embodiment, a method to modify a feeder comprises attaching a tube system to the feeder. The tube system is configured to route feed dispensed from the feeder to a set of tubes of the tube system when the tube system is attached to the feeder. The set of tubes are configured to hold the feed dispensed from the feeder in a position accessible by deer.

The features, functions, and advantages can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and advantages thereof, will best be understood by reference to the following detailed description of an illustrative embodiment of the present disclosure when read in conjunction with the accompanying drawings, wherein:

FIG. 1 is an illustration of an isometric view of a deer feeding system in accordance with an illustrative embodiment;

FIG. 2 is an illustration of a block diagram of components of a deer feeding system in accordance with an illustrative embodiment;

FIG. 3 is an illustration of a prior art deer feeder in accordance with an illustrative embodiment;

FIG. 4 is an illustration of an magnified view of a deer feeding system in accordance with an illustrative embodiment;

FIG. 5 is an illustration of a magnified view of a deer feeding system with straight feeding tubes in accordance with an illustrative embodiment; and

FIG. 6 is an illustration of a flowchart of a process for modifying a deer feeder in accordance with an illustrative embodiment.

### DETAILED DESCRIPTION

The different illustrative embodiments recognize and take into account a number of different considerations. For example, the illustrative embodiments recognize and take into account that existing products for feeding deer may be insufficient. One type of deer feeder, for example, involves slinging feed to the ground. Feeders of this type are called sling feeders. With a sling feeder, feed is stored in a container above the ground. The container of the sling feeder has a spout at the bottom that drops feed. The sling feeder also has a plate suspended below the container. Feed exiting from the spout accumulates on top of the plate.

When the height of accumulating feed reaches the spout, the accumulating feed restricts feed still in the container from exiting the spout. At programmed times a motor spins the plate. The spinning action slings the accumulated feed off the plate to the ground. When the height of the accumulated feed comes down feed in the container begins exiting the spout again.

Another type of feeder is a gravity feeder. This type of deer feeder involves using gravity to maintain a constant availability of feed. With gravity feeders a spout at the bottom of a container routes feed to feeding tubes. These feeding tubes are designed to hold feed at the end of the tubes. Feed exits through the spout of the container until the feeding tubes become full. As deer remove feed from the feeding tubes the feed in the tubes is replenished through the spout in the container. However, this type of feeder does not make the unique sound of a sling feeder. The lack of this unique sound may result in deer not being attracted to this type of feeder at a time of feeding that an operator may desire. Further this type of feeder results in feed being continuously available. Continuous availability gives deer the option to feed from the feeder at times that may not be desirable for the operator. Still further the feed in the feeding tubes is exposed to moisture. Wet feed may become damaged by mold. Feed damaged in this way can cause disease in wildlife that eats from it.

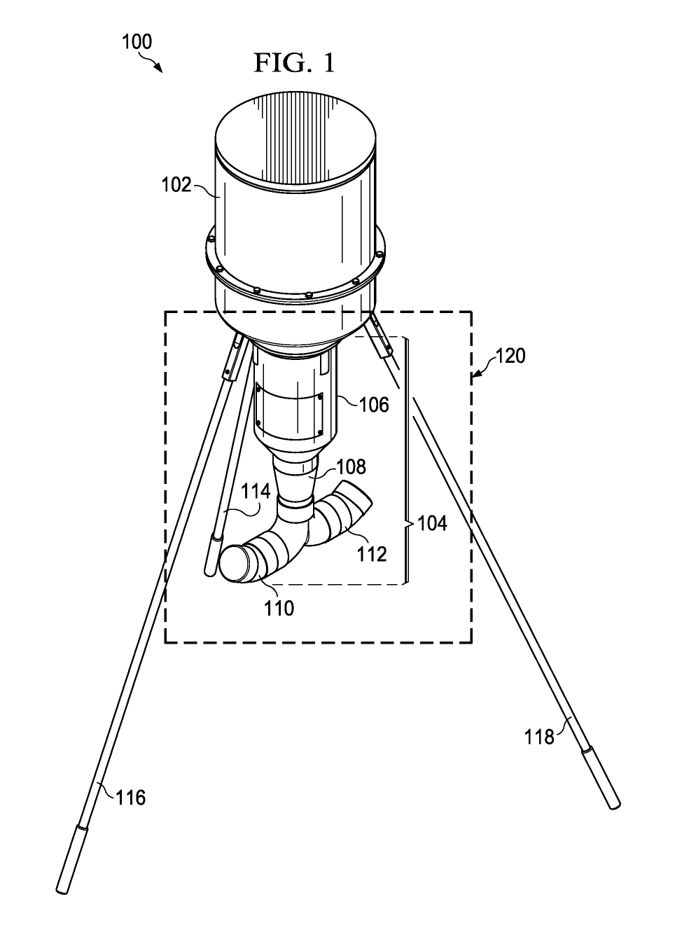

With reference now to the figures, and in particular with reference to FIG. 1, an illustration of an isometric view of a deer feeding system is depicted in accordance with an illustrative embodiment.

In this depicted example, deer feeding system 100 comprises tube system 104 attached to container 102 of a deer feeder. In this illustrative example, connector 106 of tube system 104 attaches tube system 104 to container 102.

In the depicted example, connecting tube 108 of tube system 104 attaches tube 110 and tube 112 to connector 106 of tube system 104. In this illustrative example, tube 110 and tube 112 are deer feeding tubes. As depicted tube 110 and tube 112 are configured with a portion that has at least one of an arc configured to hold feed, a slant of a sufficient degree for holding feed, or other suitable configurations for holding feed. The illustration of tube 110 and tube 112 in tube system 104 does not restrict the number or type of tubes that can be used by tube system 104. As an example, tube system 104 may include a set of tubes configured to hold feed, or any other suitable type of feeding tube for use in deer feeding system 100.

As used herein, “set of” when used with reference to items means one or more items.

As depicted, leg 114, leg 116, and leg 118 form three legs of a tripod. In this illustrated example, leg 114, leg 116, and leg 118 are configured to hold container 102 in an upright position above the ground. As depicted, leg 114, leg 116, and leg 118 are configured to raise feeding ends of tube 110 and tube 112 to a height configured to allow deer to feed.

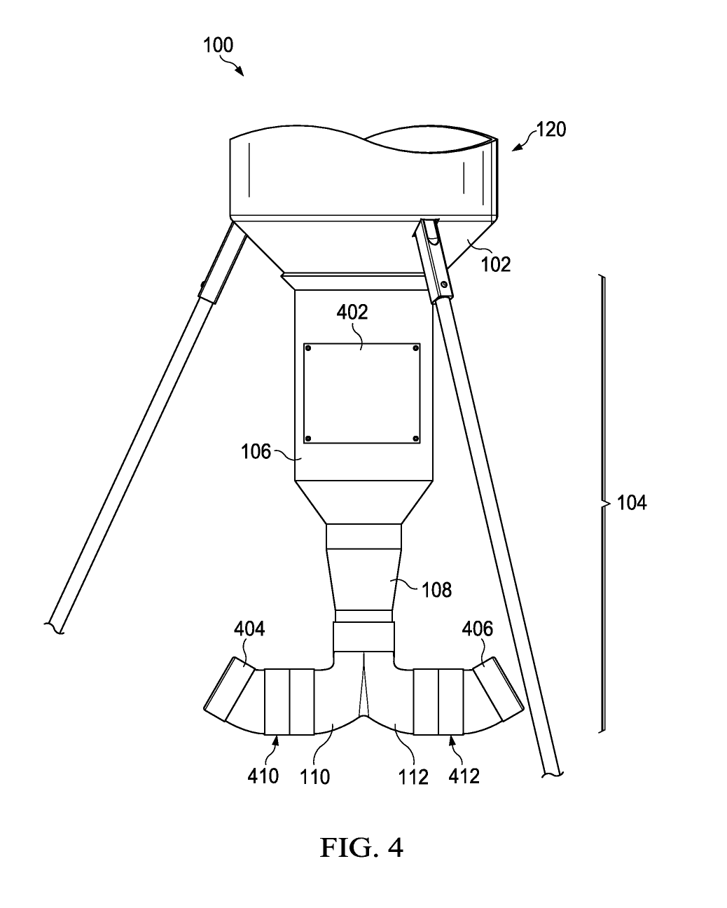

A more detailed view of tube system 104 is shown and described later. For example, FIG. 4 includes a magnified view of section 120.

The illustration of deer feeding system 100 shown in FIG. 1 is not meant to imply physical or architectural limitations to the manner in which an illustrative embodiment may be implemented. For example, instead of using leg 114, leg 116, and leg 118 to hold container 102 in the upright position at least one of a pole buried in the ground, a portion of a tree, a strap, a chain, a cable, a rope, a fastener, a wire, and other suitable types of components may also be used to hold container 102 in the upright position.

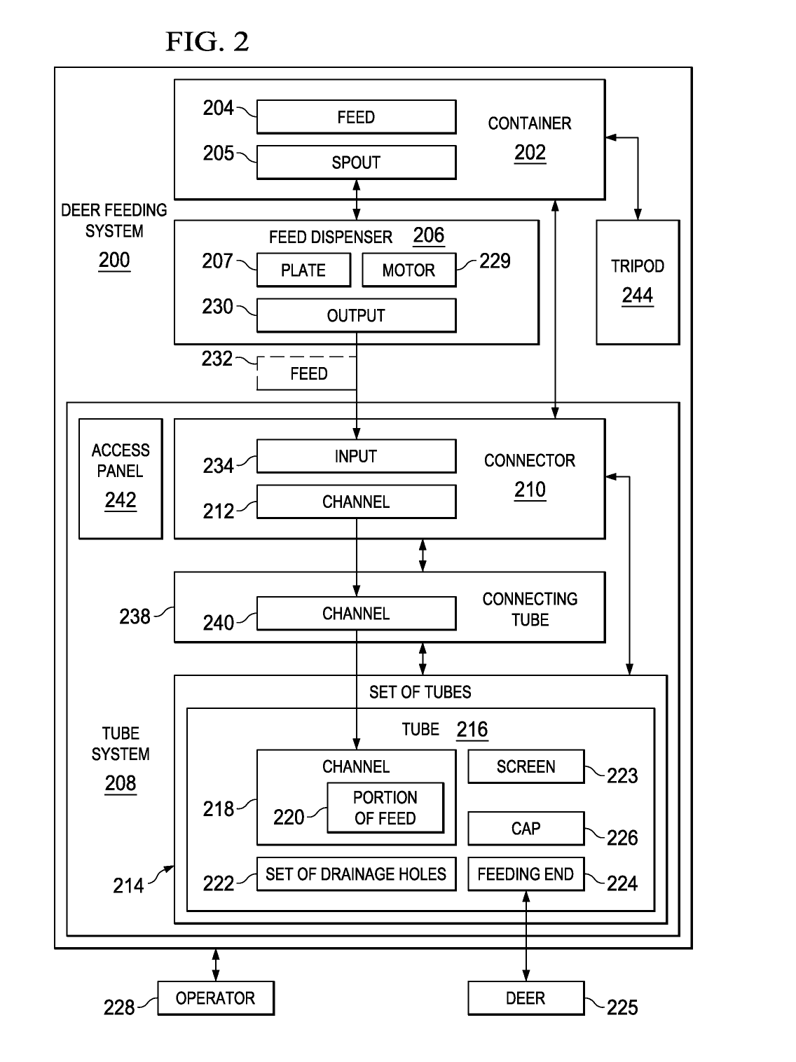

Referring now to FIG. 2, a block diagram of components of a deer feeding system is depicted in accordance with an illustrative embodiment. Deer feeding system 100 in FIG. 1 is an example of one implementation for deer feeding system 200 shown in block form in FIG. 2.

As depicted, deer feeding system 200 includes container 202. In this illustrative example, container 202 is configured to store feed 204. As used herein, feed 204 is at least one of corn, acorns, protein pellets, and other suitable types of feed for deer. For example, feed 204 may be selected to attract deer to deer feeding system 200. In this illustrative example, spout 205 of container 202 is configured to drop portions of feed 204 onto plate 207 of feed dispenser 206. In the illustrated example, plate 207 is suspended below container 202. Portions of feed exiting from spout 205 accumulate on top of plate 207. When the height of accumulating feed reaches spout 205, the accumulating feed restricts portions of feed 204 still in container 202 from exiting spout 205.

As used herein, the phrase “at least one of,” when used with a list of items, means different combinations of one or more of the listed items may be used and only one of each item in the list may be needed. For example, “at least one of item A, item B, or item C” may include, without limitation, item A, item A and item B, or item B. This example also may include item A, item B, and item C or item B and item C. Of course, any combinations of these items may be present. In other examples, “at least one of” may be, for example, without limitation, two of item A, one of item B, and ten of item C; four of item B and seven of item C; and other suitable combinations. The item may be a particular object, thing, or a category. In other words, at least one of means any combination of items and number of items may be used from the list but not all of the items in the list are required. As used herein, “number of” when used with reference to items means one or more items.

Deer feeding system 200 includes tube system 208. In these illustrative examples, tube system 208 is configured to receive and hold portions of feed 204 dispensed from feed dispenser 206. In these illustrated examples, tube system 208 is at least one of attached to container 202, attached to feed dispenser 206, suspended below feed dispenser 206, or other suitable configurations to receive and hold portions of feed 204 dispensed from feed dispenser 206. Tube system 208 is at least one of a single molded unit, or one or more separate components. In this illustrative example, tube system 208 is attached to container 202 using connector 210 of tube system 208.

In these illustrative examples, connector 210 includes channel 212 configured to route portions of feed from feed dispenser 206 to set of tubes 214. As depicted, channel 212 is a hollowed out portion of connector 210.

In this illustrative example, set of tubes 214 is configured to hold portions of feed that drop through channel 212 of connector 210. As depicted, tube 216 is an example a tube in set of tubes 214. In this illustrated example, tube 216 is configured to hold portion of feed 220 in channel 218 of tube 216. Channel 218 of tube 216 is configured with a hollow cross section having at least one of a circular shape, an elliptical shape, an egg shape, a triangular shape, a rectangular shape, or some other suitable shape. In the illustrated example, the hollow cross section of tube 216 can change in size along the length of tube 216.

In this illustrative example, tube 216 includes set of drainage holes 222. Set of drainage holes 222 is configured to drain any accumulated water from tube 216. For example, one or more of set of drainage holes 222 may be located at the lowest point of tube 216. In this example, each hole in set of drainage holes 222 is a hole in tube 216 large enough to allow water to exit from tube 216 but small enough to not allow portions of feed 204 to enter set of drainage holes 222. In this example, each hole in set of drainage holes 222 may be between 1/16″ and ⅛″ in diameter, or other suitable sizes for holes selected to allow water to exit but not allow feed 204 to enter.

As another example, screen 223 may be used with set of drainage holes 222 to allow water to exit while keeping feed 204 from entering. As still another example, set of drainage holes 222 may be absent from tube 216.

As depicted, feeding end 224 of tube 216 is configured to allow deer 225 to access portion of feed 220. In this illustrative example, feeding end 224 is an opening in tube 216 of sufficient size to allow deer 225 to feed on portion of feed 220.

In this illustrated example, cap 226 is configured to cover feeding end 224. With cap 226 placed on feeding end 224 of tube 216, deer 225 can no longer access portion of feed 220. In these illustrated examples, when drainage holes are absent from set of tubes 214 and caps have been placed on set of tubes 214, deer feeding system is fully enclosed and substantially water resistant.

In the illustrated example, operator 228 programs feed dispenser 206 to dispense portions of feed 204. In this illustrative example, feed dispenser includes motor 229. Plate 207 is attached to motor 229. The manner in which plate 207 is attached to motor 229 suspends plate 207 below spout 205. At programmed times, motor 229 is used to dispense portions of feed 204.

As depicted, feed dispenser 206 has output 230 through which portions of feed 204 are dispensed. In this illustrated example, feed 232 is an example of a portion of feed 204 dispensed from feed dispenser 206. For example, motor 229 may be configured to spin plate 207 on which feed 232 has accumulated. In this example, the spinning of plate 207 by motor 229 slings feed 232 off plate 207.

In the illustrated example, connector 210 includes input 234 in communication with output 230 of feed dispenser 206. In this illustrative example, feed 232 passes from output 230 through channel 212 in connector 210 via input 234. For example, channel 212 may be a hollow chamber configured to receive feed 232 slung off plate 207 by motor 229.

As depicted, feed 232 drops through channel 212 to fill set of tubes with portions of feed 232. In this illustrated example, portion of feed 220 is a portion of feed 232 that dropped through channel 212.

In this illustrated example, connector and set of tubes are connected by connecting tube 238. As depicted, connecting tube 238 includes channel 240. For example, channel 240 may be configured to route equal portions of feed 232 to each tube in set of tubes 214. In this illustrated example, portion of feed 220 may be an equal portion of feed 232 that dropped through channel 240 to each tube in set of tubes 214.

Access panel 242 of tube system 208 is configured to allow operator 228 to access feed dispenser 206. In the illustrative example, operator 228 may open access panel 242 to perform an action comprising at least one of programming feed dispenser 206, clearing of feed jammed in spout 205, replacing a battery of motor 229, replacing motor 229, cleaning plate 207, and other suitable actions performed by an operator of feed dispenser 206.

As depicted, tripod 244 is an example of leg 114, leg 116, and leg 118 of FIG. 1. In the illustrative example, tripod 244 is configured to suspend feeding end 224 of at least one tube in set of tubes 214 to a height configured to allow deer to feed.

In these illustrative examples, the components of tube system 208 are made of at least one of aluminum, plastic, hard rubber, copper, steel, stainless steel, and other suitable materials for components of deer feeding system 200. For example, connector 210 may be made of material selected based on the material's ability to at least one of make unique sounds, amplify sounds, or focus sounds that attract deer 225 when feed 232 is dispensed by feed dispenser 206.

In the illustrative examples, connector 210 enhances sounds emitted from feed dispenser 206 by at least one of amplifying the sounds emitted from feed dispenser 206, focusing the sounds emitted from feed dispenser 206, and emitting additional unique sounds to attract deer 225 to feed dispenser 206. For example, when feed 232 is dispensed by feed dispenser 206, feed 232 may impact upon connector 210 making additional unique sounds that attract deer 225.

The illustration of deer feeding system 200 shown in block form in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, instead of container 202, connector 210, connecting tube 238 and set of tubes 214 being individual components of tube system 208, at least one of container 202, connector 210, connecting tube 238, or set of tubes 214 may be combined with another component of deer feeding system 200.

As another example, instead of using connecting tube 238, connector 210 may be attached directly to set of tubes 214. In this example, channel 212 in connector 210 may be configured to distribute equal portions of feed 232 to each tube in set of tubes 214.

As still another example, set of drainage holes 222 in tube 216 may be opened and closed by operator 228. For example, cap 226 may be configured to cover set of drainage holes 222 when placed by operator 228 over feeding end 224. In this example, when caps have been placed over feeding ends and drainage holes of the set of tubes, deer feeding system is fully enclosed and substantially water resistant.

As a further example, access panel 242 may not be included in tube system 208. In this example, instead of operator 228 opening access panel 242 to perform an action on feed dispenser 206, operator detaches tube system 208 from container 202 to access feed dispenser 206.

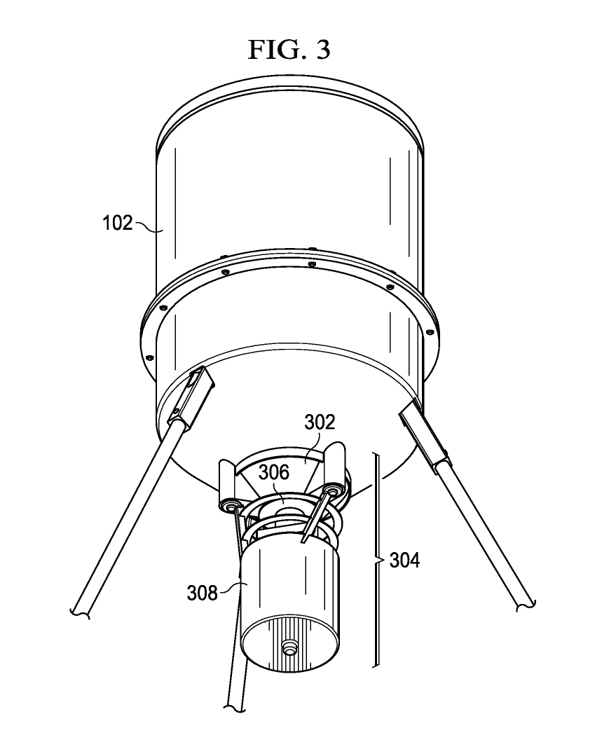

Turning next to FIG. 3, an illustration of a prior art deer feeder is depicted in accordance with an illustrative embodiment. Container 102 in FIG. 3 is an illustrative example of container 102 in FIG. 1. Spout 302 is an example of spout 205 in FIG. 2. Feed dispenser 304 is an example of feed dispenser 206 in FIG. 2. Plate 306 of feed dispenser 306 is an example of plate 207 in FIG. 2. Motor 308 is an example of motor 229 in FIG. 2.

As depicted when motor 308 spins plate 306, feed that has accumulated on top of plate 306 slings out from plate 306. As also depicted, subsequent to motor 308 no longer spinning feed coming out of spout 302 accumulates on top of plate 306 until the feed stops flowing from spout 302 due to the accumulation of feed on top of plate 306. As depicted, the spinning action slings the accumulated feed onto the ground exposing the feed to any wild life of all sizes. As also depicted, accumulated feed on plate 306 is exposed to the weather.

Turning next to FIG. 4, an illustration of a view of deer feeding system is depicted in accordance with an illustrative embodiment. In this illustration, an enlarged view of section 120 of deer feeding system 100 in FIG. 1 is shown.

As depicted, access panel 402 of connector 106 is configured to allow operator access to internal components of deer feeding system 100. For example, after removing access panel 402 from connector 106, an operator may then access a feed dispenser, such as feed dispenser 304 shown in FIG. 3. Access panel 402 is an example of access panel 242 in FIG. 2.

In this illustrated example, cap 404 on tube 110 and cap 406 on tube 112 are a set of removable caps configured to seal feeding ends of tube 110 and tube 112. For example, subsequent to an operator of deer feeding system 100 placing cap 404 on tube 110 and cap 406 on tube 112 deer feeding system 100 may become completely sealed. In this example, completely sealing deer feeding system 100 protects feed within deer feeding system 100 and components of deer feeding system 100 from bad weather.

As depicted, a portion of tube 110 has a shape that includes arc 410 and a portion of tube 112 has a shape that includes arc 412. In this illustrated example, the shape of tube 110 and tube 112 means that portions of feed distributed from feed dispenser 304 accumulate at the bottom of arc 410 of tube 110 and at the bottom of arc 412 of tube 112.

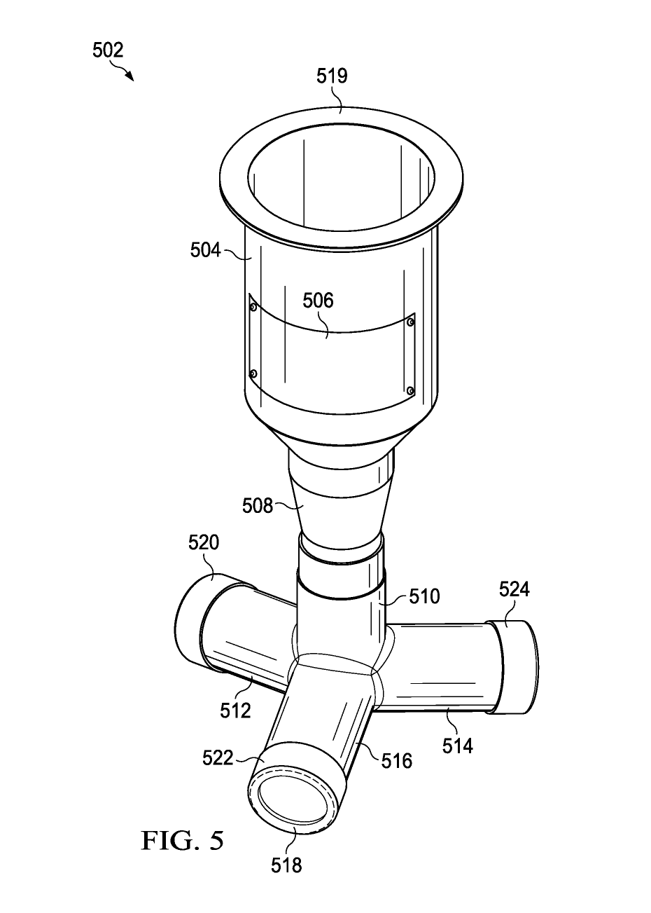

Turning next to FIG. 5, an illustration of a magnified view of a deer feeding system with straight feeding tubes is depicted in accordance with an illustrative embodiment. Tube system 502 is an example of tube system 208 in FIG. 2. Connector 504 is an example of connector 210 in FIG. 2. Access panel 506 is an example of access panel 242 in FIG. 2. Connecting tube 508 and connecting tube 510 are examples of connecting tube 238 in FIG. 2. Tube 512, tube 514, and tube 516 are examples of tube 216 in FIG. 2. In this illustrated example, lip 518 of tube 516 is configured to hold feed.

As depicted, tube system 502 communicates with a feed dispensing unit by at least one of being attached to a feed dispensing unit, being attached to a storage container that has a feed dispensing unit, being suspended below a feed dispensing unit, or other suitable ways to communicate with feed dispensing units of feed dispensing systems. In this illustrative example, connector 504 includes upper flange 519. In this illustrated example, upper flange 519 is used to attach connector 504 to a storage container that has a feed dispensing unit. For example, an operator may use upper flange 519 to attach tube system 502 to container 202 in FIG. 2. In this illustrative example, the operator may attach upper flange 519 to a container with at least one of double sided sticky tape, screws, glue, clamps, or other suitable fasteners. As depicted, with upper flange 519 attached to a storage container, tube system 502 becomes ready to receive feed from a feed dispensing unit at programmed times.

In this illustrative example, the operator may attach cap 520, cap 522, and cap 524 respectfully to tube 512, tube 516, and tube 514. In this illustrative example, cap 520, cap 522, and cap 524 are examples of cap 226 in FIG. 2. As depicted, with cap 520, cap 522, and cap 524 attached and upper flange 519 attached to a storage container, tube system 502 may become fully enclosed, substantially animal resistant, and substantially water resistant.

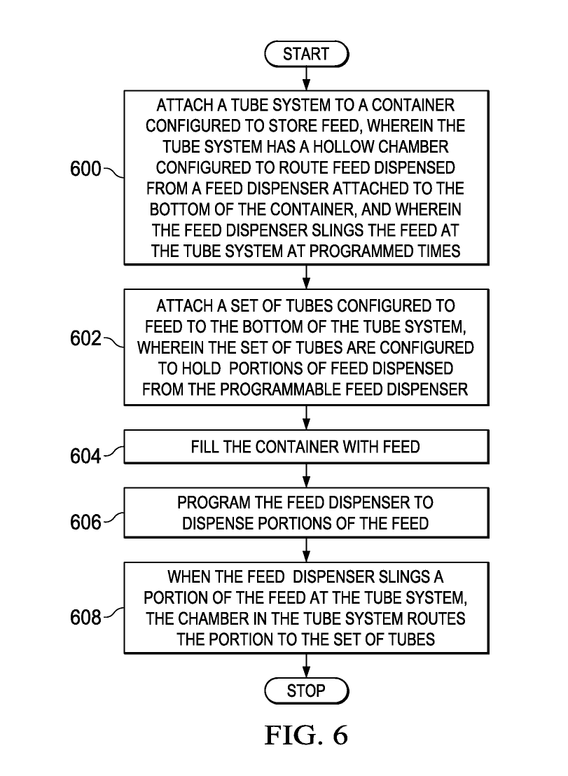

Turning now to FIG. 6, an illustration of a flowchart of a process for modifying a deer feeder is depicted in accordance with an illustrative embodiment. In this illustrative example, the process depicted in FIG. 6 may be implemented using components of deer feeding system 200 shown in block form in FIG. 2.

The process begins by attaching a tube system to a container configured to store feed, wherein the tube system has a hollow chamber configured to route feed dispensed from a feed dispenser attached to the bottom of the container, and wherein the feed dispenser slings the feed at the tube system at programmed times (operation 600). The tube system in the process is an example of tube system 208 in FIG. 2. The feed stored in the container is an example of feed 204 stored in container 202 in FIG. 2. The hollow chamber is an example of channel 212 of connector 210 in FIG. 2. The feed dispenser in this process is an example of feed dispenser 206 in FIG. 2.

The process next attaches a set of tubes configured to feed deer to the bottom of the tube system, wherein the set of tubes are configured to hold portions of feed dispensed from the programmable feed dispenser (operation 602). The set of tubes in this process is an example of set of tubes 214 in FIG. 2.

The process fills the container with feed (operation 604). The process programs the feed dispenser to dispense portions of the feed (operation 606). Then when the feed dispenser slings a portion of the feed at the tube system, the chamber in the tube system routes the portion to the set of tubes (operation 608), with the process terminating thereafter.

Of course, other operations (not shown in this figure) may also be performed prior to the process terminating. For example, the operation that programs the feed dispenser to dispense portions of the feed may also include other operations that use an access panel to gain access to the feed dispenser. In this example, the other operations may include opening the access panel to access the feed dispenser and then closing the access panel. The access panel in these other operations is an example of access panel 242 in FIG. 2.

Thus, the illustrative embodiments provide a system and apparatus for feeding deer. A feeder is configured with a container to store feed. The feeder is also configured with a feed dispenser. The feed dispenser is physically associated with the container and has an output. The feed dispenser is configured to dispense a portion of the feed from the container through the output. The feeder is further configured with a tube system that has an input in communication with the output of the feed dispenser. The tube system is configured to receive at the input the portion of the feed dispensed by the feed dispenser through the output of the feed dispenser and hold the feed in a position accessible by deer.

In the illustrative examples, the deer feeding system is configured to easily feed deer. The use of the feeding tubes in communication with the feed dispenser does not require removal of the feed dispensing unit that deer have learned to associate with feeding. The use of the feeding tubes reduces an amount of feed that is normally wasted by sling feeders when the feed is tossed to the ground. The used of the deer feeding system also protects the feed and the feed dispenser from the elements. The use of the deer feeding system further enhances sounds made by feed dispenser to attract deer to the deer feeding system.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1. A feeder comprising:
a container configured to store feed;
a feed dispenser physically associated with the container and having an output, wherein the feed dispenser is configured to dispense a portion of the feed from the container through the output; and
a tube system having an input in communication with the output of the feed dispenser, wherein the tube system is configured to receive at the input the portion of the feed dispensed by the feed dispenser through the output of the feed dispenser and hold the feed in a position accessible by deer, and wherein the tube system is made of a type of material selected to at least one of amplify sounds from the feeder, focus sounds from the feeder, and emit additional unique sounds from the feeder to attract deer when the portion of the feed is dispensed.

2. The feeder of claim 1, wherein the tube system comprises:
a connector having the input in communication with the output of the feed dispenser; and
a set of tubes configured to hold the portion of the feed in the position accessible by deer when the portion of the feed is dispensed.

3. The feeder of claim 2, wherein the set of tubes has a portion with an arc configured to hold the portion of the feed in the position.

4. The feeder of claim 3, wherein the tube system includes a hollow chamber configured to route the portion of the feed in equal portions to each of the set of tubes.

5. The feeder of claim 2, wherein the tube system includes a connecting tube configured to route the portion of the feed dispensed by the feed dispenser to the set of tubes, and wherein each tube in the set of tubes is a hollow cylinder having an axis that is perpendicular to the connecting tube.

6. The feeder of claim 5, wherein a feeding end of at least one tube in the set of tubes comprises a lip configured to hold feed.

7. The feeder of claim 1, wherein the type of material is selected from one of copper, steel, stainless steel, aluminum, plastic, and hard rubber.

8. The feeder of claim 2, wherein the set of tubes has one or more holes configured to drain water.

9. The feeder of claim 1, wherein the feed dispenser is programmable and the tube system includes at least one of an access panel configured to allow access to the feed dispenser, and a connector configured to allow access to the feed dispenser, wherein the connector has the input in communication with the output of the feed dispenser and the connector includes at least one of clamps and screws to allow access to the feed dispenser.

10. The feeder of claim 2, further comprising:
a set of removable caps configured to seal feeding ends of the set of tubes.

11. The feeder of claim 2, further comprising:
at least one of a tripod, a pole, a portion of a tree, a strap, a chain, a cable, a rope, a fastener, and a wire configured to hold the container in an upright position above ground and raise a feeding end of at least one tube in the set of tubes to a height configured to allow deer to feed.

12-19. (canceled)

20. A system to feed deer, the system comprising:
a containing unit configured to store feed;
a feed dispensing unit physically associated with the containing unit and having an output that is programmable, wherein the feed dispensing unit is configured to dispense a portion of the feed from the containing unit through the output; and
a tube system having an input in communication with the output of the feed dispensing unit, wherein the tube system is configured to receive at the input the portion of the feed dispensed by the feed dispensing unit through the output of the feed dispensing unit and hold the feed in a position accessible by deer, and wherein the tube system is made of a type of material selected to at least one of amplify sounds from the feeder, focus sounds from the feeder, and emit additional unique sounds from the feeder to attract deer when the portion of the feed is dispensed.
